(19) United States
(12) Patent Application Publication
(10) Pub. No.: US 2010/0201523 A1
(43) Pub. Date: Aug. 12, 2010

(54) DEVICE FOR DETECTING NEWBORN DISPLACEMENT

(76) Inventor: Marco Tommaseo, Milano (IT)

Correspondence Address: Pearne & Gordon LLP, 1801 East 9th Street, Suite 1200, Cleveland, OH, 44114-3108, US

(21) Appl. No.: 12/446,109

(22) PCT Filed: Oct. 16, 2007
(86) PCT No.: PCT/IB07/54214

§ 371 Date: Apr. 17, 2009

(30) Foreign Application Priority Data
Oct. 17, 2006 (IT) MI2006U000356

(51) Int. Cl. G08B 23/00

(52) U.S. Cl. 340/573.1

(57) ABSTRACT

A device for detecting newborn displacement comprising: a clamp (2) applicable to the umbilical cord of a newborn baby; detecting means (14) to recognise passage of the newborn entering and exiting a respective area (15); and a passive element (13) in engagement with said clamp (2) and adapted to co-operate with said detecting means (14) to signal passage of the baby in and/or out of said area (15). The passive element (13) is inserted in a seat (6) present in the clamp (2) and has a protective casing (19) designed to protect a thin metal plate (20) disposed inside the casing against moisture.

The present invention relates to a device for detecting newborn displacement. In particular, the invention is used for detecting entries/exits of newborn babies through predetermined areas, such as neonatal medicine wards in hospitals, in order to control displacements or also avoid kidnappings of minors at the inside of the hospitals themselves.

It is known that particularly in hospitals control/safety devices for the above mentioned purposes. are presently required, although this necessity is still partly unsatisfied.

The most innovative proposals in this regard concern use of the well-known identification bracelets worn by the babies and applied by the hospital staff to the mother and the baby at birth and with which a suitable electronic device is associated which can allow identification of the newborn baby and also control of his/her passage on entering and/or exiting a monitored region.

Generally, these electronic devices applied to the bracelet consist of an identification transponder system and a wireless detecting microchip (also known as “RFID” and based on remote reading, by radio waves, of information contained in the microchip). The microchip is merely applied to the identification bracelet currently used to identify each newborn baby. Data reading is carried out by means of an antenna enabling data reception and transmission by radio frequency from and to the microchip that is in the vicinity and that allows the detected information to be consequently transferred to an electronic processing box. The antennas are placed at predetermined areas, at the doors for exit from the neonatal medicine wards for example. In this manner, when the newborn baby provided with said bracelet is moved through the doors, the antenna picks up the information contained in the microchip and sends a signal to the electronic box that records the occurred passage and possibly carries out activation of suitable acoustic alarm signallers.

However, the solution briefly described above has some problems.

First of all it is to be noted that the bracelet placed around the baby's wrist can be easily removed. Consequently, if the bracelet is slipped off, cut or torn, the baby can be moved and taken away, eluding the detecting system. In addition, the electronic structure of the microchip contained in the bracelet appears to be rather delicate and therefore can be easily damaged as a result of an incorrect use by the hospital staff.

A further drawback resides in that the radio frequency picked up by the antenna can be jammed by interferences of electromagnetic nature or also due to particular orientations of the microchip. In fact, if the bracelet containing the microchip is concealed or shielded as it is covered or positioned in a bad manner, the antenna does not detect passage through the monitored region.

These problems have been dealt with and partly solved by patents U.S. Pat. No. 5,440,295 and U.S. Pat. No. 5,608,382, for example.

These documents teach use of a clamp for umbilical cords with which an element for baby identification can be irremovably associated.

In particular these devices contemplate insertion of the identification device at the junction ring between the upper and lower arms of the clamp. When the clamp is closed on the umbilical cord, the transponder device inserted therein keeps visible but irremovably linked to the device itself. These devices however have some important limits.

First of all the device associated with the clamp is rather bulky and therefore can be bothersome for the baby. In addition, should the physician forget inserting it in the suitable seat, the baby displacement could not be controlled any longer since it is impossible to insert this device after closure of the clamp.

In addition, since these devices are placed externally, they are greatly affected by moisture that is typically present in the application area and is due to the baby's different corporal fluids.

In addition, the presence of an identification system can involve non-negligible problems about privacy or at least privacy management by the medical structures utilising this system.

It is a first aim of the invention to make available a device for detecting displacements of newborn babies that is simple, of reduced bulkiness and cheap, but that, at the same time, is also able not to be tampered with or removed with ease from the newborn baby.

A washing A further aim of the present invention is to make available a detecting device that is reliable, can be hardly damaged and is efficient.

The invention also aims at making available a detecting device that does not suffer for the surrounding humidity so that it is able to ensure a very high operating reliability.

Another aim of the invention is to enable detection of the newborn passages in an anonymous manner so that possible privacy problems can be bypassed.

Ultimately, the invention aims at enabling an easy and simple management of the alarms without causing particular problems every time an authorised displacement of the baby is required.

The foregoing and further aims that will become more apparent in the progress of the description are substantially achieved by, a device for detecting newborn displacement, in accordance with the invention.

Further features and advantages will be best understood from the detailed description of a detecting device in accordance with the appended claims.

A preferred but not exclusive embodiment of a device for detecting newborn displacement is given hereinafter with the aid of the accompanying drawings, in which:

FIG. 1 is a perspective view of a detecting device in accordance with the present invention;

FIG. 2 is ah elevation side view in an open configuration of the device shown in FIG. 1;

FIG. 3 is an elevation side view in a closed configuration of the device shown in FIG. 1;

FIG. 3a is a cross-section view taken along line III-III of the device shown in FIG. 3; and

FIG. 3b is an exploded diagrammatic view of the operating means 7 of the device seen in FIG. 3a; and

FIG. 4 is a diagrammatic perspective view of a monitored region wherein passage in and out of the newborn baby is checked.

With reference to the drawings, a device for detecting newborn displacement has been generally identified with reference numeral 1. In particular, the present invention advantageously applies to hospitals, nursing homes or other places where monitoring of displacements is necessary or also where newborn kidnapping can take place.

Device 1 is generally made up of a clamp 2, to be applied at birth to the umbilical cord of a baby, and provided with a pair of arms 3 of elongated conformation. In particular, arms 3 are elastically connected with each other at respective first ends 3a to be movable between an open condition (FIGS. 1 and 2) at which they are moved apart from each other and a closed condition (FIG. 3) at which they are disposed close to each other to pinch said umbilical cord.

Each arm 3 preferably although not necessarily has a parallelepiped conformation with rectangular cross section and a contact surface 4 provided with knurling to promote optimal anchoring of the whole clamp 2 to the umbilical cord.

It will be appreciated that the contact surfaces 4 of arms 3 face each other so that the knurled area of one contact surface 4 firmly matches that of the other. In other words, as shown in FIG. 3, each contact surface 4 of one arm 3 has projections 4a defining said knurling and insertable in suitable recesses 4b of the contact surface 4 of the other arm 3.

Each arm 3 further has a pair of flat side surfaces 5 substantially perpendicular to the contact surface 4 and opposite to each other.

Advantageously, a side surface 5 of a respective arm 3 is provided with a seat 6 preferably longitudinally extending along the whole clamp 2.

As better shown in FIG. 3a, seat 6 consists of a blind opening inside which operating means 7 better described in the following of the present treatment is housed. It is to be pointed out that in the accompanying figures one seat alone 6 formed in one of the arms 3 of clamp 2 is illustrated by way of non-limiting example. However, the number of seats 6, as well as the size and positioning of same can be of any type depending on the conformation and nature of said operating means 7.

For instance, the operating means 7 can be provided to be secured by an adhesive 27 to an inner surface of said seat 6 which remains open.

Alternatively, the operating means 7 can be inserted in this seat 6 and the seat itself can be suitably sealed by means of resins or plastic materials; in this way the operating means 7 is actually buried in arm 3.

Still alternatively, use of a closing body can be envisaged, such as a cover adapted to close or seal access to seat 6 thus concealing said operating means 7 to the sight.

Generally and in order not to modify the ergonomic. character and the medical methodology presently used, the operating means 7, which takes a substantially laminar shape, is disposed internally of the cavity having its major extension surface parallel to respective pressure surfaces 23, i.e. the surfaces on which the physician exerts pressure with his/her hands to close clamp 2 in the newborn's umbilical cord.

This particular arrangement of the operating means 7 in seat 6 enables the normal sizes of clamp 2 to be maintained substantially unchanged; in particular, an increase in the thickness or height of the side surface is avoided, which would involve an excessive stiffness of the structure.

Clamp 2 further has an elastically deformable portion 8 coupled to the first ends 3a of arms 3, which portion 8 allows manual movement of arms 3 close to and away from each other.

In more detail, the elastically deformable portion 8 consists of an arched element 8a having respective opposite ends connected to the first ends 3a of arms 3.

Preferably, arms 3 and arched element 8a are of one piece construction and made of a resilient material such as plastic material.

Clamp 2 further comprises an irreversible-engagement member 9 disposed close to second ends 3b of arms 3, opposite to said first ends 3.

The engagement member 9 is adapted to firmly couple arms 3 to each other in the respective closed condition shown in FIG. 3 and in section view in FIG. 3a. In other words, the engagement member 9 carries out engagement of the two arms 3 in such a manner that they remain firmly associated with each other without any possibility of separation, except through a forced intervention usually involving breaking of the engagement member 9.

It is however apparent that possible removal of the umbilical clamp can give rise to haemorrhages in the newborn baby that could be dangerous for the baby and be immediately noticed by the medical staff.

In detail, member 9 comprises a pair of hooking projections 10 each of which is disposed in a respective arm 3 and extends transversely of the contact surface 4.

Each hooking projection 10 has an undercut 11 associable with a connecting edge 12 disposed close to the opposite projection 10. In more detail, as shown in FIG. 3, the connecting edges 12 are inserted in the undercuts 11 of the respective projections 10 to define a steady coupling of arms 3.

As above mentioned, at least one arm 3 of the clamp 2 is provided with operating means 7 enabling monitoring of the displacements of the newborn baby through the checked regions.

Generally the operating means 7 will comprise a generally passive element 13 and will be designed to be inserted and housed in said seat 6 formed internally of at least one of the two arms 3 of the umbilical clamp 2.

Due to its nature, the operating means 7 does not require any type of electric power in situ and said means will be all identical with each other so that no type of identification of the specific umbilical clamp or of the baby to which said clamp is applied is made possible.

In other words, the operating means 7 will be adapted to exclusively allow detection of passage of the newborn baby through predetermined regions. More specifically, passage of a specific clamp or of another different clamp through a monitored region will exclusively allow detection of this passage without supplying any further information as regards the subject passing through said way.

Generally systems of the magnetic or acoustic-magnetic nature are to be preferred. At all events the passive element 13 is provided with an outer protective casing 19 containing at least one inner thin metal plate 20. In particular the main aim of the outer protective casing 19, that can be made of plastic material such as polystyrene or polypropylene, is to protect the inner metal elements to be described in the following from moisture that could damage or prevent operation of the operating means 7. In particular the inner thin metal plate 20 feels the electromagnetic field generated by sensor means (described in the following) and will enable a suitable sensor 16 to pick up the presence thereof on passing therethrough.

From a structural point of view, a preferred embodiment of this element 13 is shown in FIG. 3b. Said outer protective casing 19 consists of an upper cover 10a coupled to a plastic closing element 19b to be sealed to cover 19a. At least one first thin plate 20 consisting of amorphous plastic material generally having a very low value of magnetic saturation is present inside said casing 19. It is in particular a ferromagnetic material typically containing iron, nickel and chromium.

Also present inside said casing 19 is a separator 29 of plastic material (polyethylene or polyester material) defined by a thin plate and designed to avoid contact between said first thin metal plate 20 and at least one second thin metal plate 24.

The second thin metal plate 24 consists of an amorphous metal and in particular an iron-based alloy containing nickel, cobalt, boron and silicon.

In the embodiment shown two of these thin metal plates or resounding elements 24 are shown.

The first and second thin plates 20, 24 are not linked together but are free to mechanically oscillate with respect to each other.

When in particular the ferromagnetic material is magnetised, the two thin plates can be excited through a suitable magnetic field (by way of example a magnetic field at 58 or 66 KHertz can be utilised) inducing a magnetic resonance by magnetostriction.

When the magnetic field is deactivated the thin plates go on oscillating with respect to each other, producing a magnetic signal due to magnetisation of the thin plate of ferromagnetic material. The signal thus generated can be detected by sensor 16.

From the above it is apparent that the operating means 7 is adapted to co-operate with the detecting means 14 which detects passage of a newborn baby provided with the above described clamp 2 entering and/or going out of a respective area 15, identified with a room as shown in FIG. 4 by way of example.

In particular, the detecting means 14 detects passage of the operating means 7 entering and/or going out of said area 15 by means of a sensor (generally of a magnetic field) 16 adapted to pick up the presence of the passive element 13 on passage through the monitored region or check region 17. For instance, still referring to FIG. 4, the magnetic sensor 16 can consist of a pair of columns 16a facing each other at the entry/exit door of a room defining said area 15.

These columns further have a magnetic-field generator 18 (that can coincide with said sensor or not) acting in the monitored region 17 through which passage of element 13 is detected.

As already previously mentioned, the magnetic-field generator 18 is able to produce a magnetic field (at 58 or 66 KHertz, for example) inducing a magnetic resonance by magnetostriction in the passive element 13 and in particular driving the first and second thin metal plates 20, 24 in relative oscillation.

Sensor 16 detects the magnetic signal produced by mechanical vibration of the magnetised thin plates of the passive element 13, which signal is indicative of passage of one of said elements through an access to the monitored region 17.

In this manner, when a newborn baby provided with the above described clamp 2 is carried through the monitored region 17, the passive element 13 co-operates with the magnetic field present between columns 16 and activates a control unit (not shown in the accompanying figures) that will generate a signal representative of the newborn passage in and out of the baby's area.

It will be recognised that the signal generated by the control unit will always be the same irrespective of which passive element 13 passes through the monitored region. This means that passage through said region is absolutely anonymous without identification of the newborn baby.

Advantageously, this signal can be recorded and possibly connected to an acoustic signaller warning about the newborn passage.

In addition, a visual signalling device such as a flashing light or the like is generally activated and possibly a safety videocamera is operated to record the newborn's and adult's passage.

It is in fact to be noted that the combined actions involving passage monitoring, acoustic and/or visual signalling and video recording increase safety of the system and constitute a strong deterrent to kidnapping of minors.

It is also to be pointed out that the system can advantageously comprise means 21 for temporary deactivation of said alarm, drivable by an operator before passing in and out of said area 15.

The above will enable newborn displacement to be carried out by the authorised staff when required without said alarm being generated.

It will be appreciated that typically deactivation only concerns generation of the alarm, i.e. of the acoustic and/or optical signal informing about the newborn passage. Vice versa, recording of data concerning passage and possibly also visual recording of said passage are maintained.

In an alternative embodiment it is also possible to provide that the temporary deactivation means 21 should also stop generation of the signal representative of the passage in and out of the newborn's area.

Generally, the deactivation means 21 will allow the alarm generation to be stopped for a predetermined period of time generally sufficient for passage through the monitored region 17. When this time interval has elapsed, the system will automatically go back to the normal working condition.

The temporary deactivation means 21 can be of different nature, but said means preferably consists of a reader of fingerprints 22 or more generally of a biometric sensor.

Alternatively, use of a card such as a magnetic identification card, a chip card or an optical reading card can be provided.

It will be recognised that use of the temporary deactivation means 21 is very advantageous also without taking into account use of a passive element 13 of the magnetic-acoustic type. This temporary deactivation means 21 could be used in combination with different systems for passage recording which also allow identification of the newborn baby.

In addition, in the umbilical clamp it is also possible to envisage the adoption of means for identification of the newborn, i.e. in an arm 3 it will be possible to insert a chip or in any case a system of the RFID type 25 containing the identification data of the baby so that the system can not only enable monitoring of the movements, but also identification of the newborn and also further personal data to be drawn directly from the clamp.

This RFID module 25 can be read not only by a suitable reading device 26 placed at the monitored region 17 for example, so as to identify the baby during his/her displacements, but also by a normal portable reading device 27 in order to control other aspects of the baby's care and typical of the hospital.

For instance, through the portable reading device 26 it will be possible to control the “milk bank”, i.e. it will be possible to recognise through unique codes, which milk is to be given to a specific baby, thereby enabling an electronic control to be added to the human control carried out by the operator.

The invention achieves important advantages.

First of all device 1 is particularly reliable because clamp 2 inside which the operating means 7 is housed is engaged in an irremovable manner to the baby's umbilical cord. Consequently, clamp 2 cannot be tampered with or removed without the medical staff becoming aware of this fact. In addition, detection of the newborn passage through region 17 is not influenced by the orientation of the clamp 2 itself. In fact, detection of element 13 takes place irrespective of the orientation of the element itself, due to the presence of a magnetic field between columns 16a, and the system is therefore very reliable.

A further advantage is represented by the structure of the operating means 7 merely consisting of a small bar incorporating a passive transponder, which bar can be hardly damaged due to disordered movements of the newborn or the medical staff and does not need any external power supply.

In addition, this solution has a very reduced bulkiness enabling easy installation in the clamp without any inconvenience for the newborn; actually it represents the only technologically reliable solution presently feasible and applicable to the umbilical clamp. Due to adoption of a protective casing for the passive element 13, the system is quite insensitive to moisture, which makes it still more reliable in operation.

Finally, due to the presence of the means for deactivating the alarm, the authorised displacements of babies at the inside of the structure can be controlled in an optimal manner.

1-8. (canceled)

9. A device for detecting newborn displacement comprising:
a predetermined number of clamps, each applicable to the umbilical cord of a respective newborn baby;
detecting means to recognise passage of a newborn baby entering and/or exiting a respective area;
operating means comprising at least one element which is a passive element, said means being inserted and housed in a seat formed internally of at least one respective arm of said clamp, and co-operating with said detecting means when the operating means itself moves in and/or out of said area, wherein said detecting means comprises at least one magnetic-field sensor designed to pick up the presence of said element passing through a monitored region or check region and to emit a signal representative of passage of said passive element in and/or out of said area, said signal generating an alarm, which detecting means does not identify, by means of said element, the subject passing there through but exclusively detects passage of same, and wherein said element comprises an outer protective casing and at least one thin metal plate placed internally of said casing and adapted to feel said electromagnetic field and to enable said sensor to pick up the presence thereof.

10. A device as claimed in claim 9, wherein said clamp comprises a pair of arms elastically connected to each other, at first ends thereof, for movement between an open condition at which they are moved apart from each other and a closed condition at which they are moved close to each other; said seat being formed in at least one of said arms.

11. A device as claimed in claim 10, wherein said arms comprise respective contact surfaces facing each other for engagement of the respective umbilical cord on opposite parts, each arm further having a pair of side surfaces transverse to said contact surface, said arms also comprising respective pressure surfaces transverse to said side surfaces and opposite to said contact surfaces, said element being of laminar shape and being engaged in said seat with its major extension surface parallel to said pressure surfaces.

12. A device as claimed in claim 9, wherein said element further comprises at least one second thin metal plate which is free to oscillate relative to said first thin plate.

13. A device as claimed in claim 9, wherein said detecting means further comprises a magnetic-field generator operating at said monitored region, said generator generating a magnetic field inducing a mechanical resonance in said first and second thin plates when the magnetic field generated by the generator is removed, the thin plates oscillating and producing a magnetic signal detected by said sensor.

14. A device as claimed in claim 12, wherein said first thin plate is made of an amorphous metal material and said second thin plate is made of ferromagnetic material.

15. A device as claimed in claim 9, wherein said operating means further comprises an RFID module irremovably in engagement with an arm of said clamp, the detecting device further comprising a reading device to read the identification data contained in said RFID module, said reading device being used for identifying the newborn baby entering and/or exiting the respective area.

16. A device for detecting newborn displacement comprising:
a predetermined number of clamps, each applicable to the umbilical cord of a respective newborn baby;
detecting means to recognise passage of a newborn baby entering and/or exiting a respective area;
operating means comprising at least one element which is a passive element, said means being inserted and housed in a seat formed internally of at least one respective arm of said clamp, and co-operating with said detecting means when the operating means itself moves in and/or out of said area, wherein said detecting means comprises at least one magnetic-field sensor designed to pick up the presence of said element passing through a monitored region or check region and to emit a signal representative of passage of said passive element in and/or out of said area, said signal generating an alarm, which detecting means does not identify, by means of said element, the subject passing there through but exclusively detects passage of same, and wherein said element comprises an outer protective casing and at least one thin metal plate placed internally of said casing and adapted to feel said electromagnetic field and to enable said sensor to pick up the presence thereof and wherein the device comprises means for temporary deactivation of said alarm, associated with the detecting means and drivable by an operator before passing through the monitored region for entering and/or exiting said area.

17. A device as claimed in claim 16, wherein said means for temporary deactivation of said alarm comprises a fingerprint reader, or a card reader adapted to deactivate said alarm for a predetermined time interval.

18. A device for detecting newborn displacement comprising:
a predetermined number of clamps, each applicable to the umbilical cord of a respective newborn baby;
detecting means to recognise passage of a newborn baby entering and/or exiting a respective area;
operating means comprising at least one element, said means being inserted and housed in a seat formed internally of at least one respective arm of said clamp, and co-operating with said detecting means when the operating means itself moves in and/or out of said area, wherein said detecting means comprises at least one magnetic-field sensor designed to pick up the presence of said element passing through a monitored region or check region and to emit a signal representative of passage of said passive element in and/or out of said area, which detecting means does not identify, by means of said element, the subject passing there through but exclusively detects passage of same, and wherein said element comprises an outer protective casing and at least one thin metal plate placed internally of said casing and adapted to feel said electromagnetic field and to enable said sensor to pick up the presence thereof, said clamp comprising a pair of arms elastically connected to each other, at first ends thereof, for movement between an open condition at which they are moved apart from each other and a closed condition at which they are moved close to each other; said seat being formed in at least one of said arms and wherein said arms comprise respective contact surfaces facing each other for engagement of the respective umbilical cord on opposite parts, each arm further having a pair of side surfaces transverse to said contact surface, said arms also comprising respective pressure surfaces transverse to said side surfaces and opposite to said contact surfaces, said element being of laminar shape and being engaged in said seat with its major extension surface parallel to said pressure surfaces, wherein said element further comprises at least one second thin metal plate which is free to oscillate relative to said first thin plate.
